(19) United States
(12) Patent Application Publication
(10) Pub. No.: US 2026/0339744 A1
(43) Pub. Date: Oct. 29, 2026

(54) DEEP LEARNING MODEL REASONING ACCELERATION METHOD BASED ON CLOUD-EDGE-END COLLABORATION

(71) Applicant: Nanjing University Of Posts And Telecommunications, Jiangsu (CN)

(72) Inventors: Yongan GUO, Jiangsu (CN); Jinliang ZHOU, Jiangsu (CN); Yuao WANG, Jiangsu (CN); Qijie QIAN, Jiangsu (CN); Hongbo SUN, Jiangsu (CN)

(73) Assignee: Nanjing University Of Posts And Telecommunications, Jiangsu (CN)

(21) Appl. No.: 19/102,414

(22) PCT Filed: Jun. 7, 2023
(86) PCT No.: PCT/CN2023/098730

§ 371 Date: Feb. 10, 2025

(30) Foreign Application Priority Data
Aug. 11, 2022 (CN) 202210961978.9

(51) Int. Cl. G06F 9/50; G06N 3/063; G06N 3/092

(52) U.S. Cl. CPC G06F 9/5072; G06N 3/063; G06N 3/092

(57) ABSTRACT

The disclosure provides a deep learning model reasoning acceleration method based on cloud-edge-end collaboration, and specifically relates to a deep learning model hierarchical offloading method. According to the method, theoretical modeling is performed on a computing delay, a data transmission delay, a data propagation delay, and a model hierarchical offloading policy generation delay in a whole deep learning model reasoning process, and a hierarchical offloading policy of an optimal deep learning model is determined by using the minimum computing task response delay as an optimization target. Compared with deep learning model execution frameworks dominated by a physical end and a cloud computing center, according to the method, an edge computing paradigm and cloud computing are combined, and a deep learning model is hierarchically offloaded to different edge computing nodes, so that the computing task response delay is minimized when the computing precision is met.

### TECHNICAL FIELD

The present disclosure relates to the technical field of cloud-edge-end collaborative computation, and specifically relates to a deep learning model reasoning acceleration method based on cloud-edge-end collaboration.

### RELATED ART

The intelligent application programs based on the deep learning model typically require a large amount of computations, and two feasible solutions exist at present. One is the End-only mode, that is, simple models and lightweight deep learning model frameworks are used at the physical terminal to perform all the computations, such as TensorFlow Lite and Caffe For Android. The second is the Cloud-only mode, that is, all computing tasks are offloaded to a powerful cloud center for complex deep learning model computations. However, the above methods may either reduce recognition accuracy by deploying merely a simple model on the physical terminal, or result in excessive transmission delay overhead due to the unstable wide area network transmission links between the physical terminal and the cloud. Therefore, it is quite difficult to ensure the reasonable delay and the recognition accuracy at the same time.

In order to eliminate the contradiction between the delay and the recognition accuracy, the edge computing paradigm is utilized as a better solution. However, due to ignoring the characteristics of deep learning applications and the dynamic nature of the edge environment, the existing edge computing execution framework and offloading mechanism for deep learning model reasoning still have a plurality of limitations.

### SUMMARY OF INVENTION

The objectives of the present disclosure are that: by combining the edge computing paradigm and the cloud computing, and offloading the deep learning model to different edge computing nodes in layers, the response delay of the computing tasks is minimized under the premise of satisfying the computing accuracy.

In order to achieve above objectives, the present disclosure provides following technical solutions. Provided is a deep learning model reasoning acceleration method based on cloud-edge-end collaboration, the cloud-edge-end collaboration refers to a cloud server, at least two edge computing nodes in communication with the cloud server, and at least one physical terminal, and a communication distance between the physical terminal and the edge computing nodes is less than a distance between the edge computing nodes and the cloud server, and the method includes following steps:

In step S1, image data are pre-processed by the physical terminal into image feature data D₁ with the same resolution and equal data volume, each divided DNN layer of a divided deep learning model to be offloaded, that is DNN_{z}, is input, and an output of a previous layer is taken as an input of a next layer, and image feature data D_{z} are eventually obtained.

In step S2, an offline learning stage is executed: a resource preset load condition is calculated according to each edge computing node. By taking a process of processing the image feature data D_{z} through the each divided DNN_{z} layer of the deep learning model to be offloaded on the each edge computing node as an input, and taking a computing delay corresponding to the known image feature data D_{z} passing through each DNN_{z} layer of the deep learning model to be offloaded on the each edge computing node as an output, a hierarchical computing delay prediction model CT is constructed and trained.

At the same time, by taking a process of processing the image feature data D_{z} through the each divided DNN_{z} layer of the learning model to be offloaded on the cloud server as an input, taking a computing delay corresponding to the image feature data D_{z} passing through each DNN_{z} layer of the deep learning model to be offloaded on a known cloud server as an output, a cloud server computing delay prediction model CT_{c} based on a preset load condition of a computing resource of the cloud server is constructed and trained.

In step S3, hierarchical computing delay prediction model CT is applied according to an actual load condition of the computing resource of the each edge computing node. A theoretical hierarchical computing delay CT′ is obtained by taking the process of processing the image feature data D_{z} through the each DNN_{z} layer of the deep learning model to be offloaded on the each edge computing node as an input, and taking a computing delay corresponding to the known image feature data D_{z} passing through each DNN_{z} layer of the deep learning model to be offloaded on the each edge computing node as an output.

In step S4, a data transmission delay T and a propagation delay S required by transmitting the image feature data D_{z} passing through a current edge computing node to other edge computing nodes are calculated based on a local area network bandwidth condition r of known edge computing nodes and physical distances l between the each edge computing node. At the same time, a data transmission delay T_{c} and a propagation delay Sc required by transmitting the image feature data D₁ passing through the edge computing node of the computing node to the cloud server are calculated based on a network bandwidth condition r_{c} of the known cloud server as well as physical distances l_{c} between edge computing nodes of a computing task and the cloud server.

In step S5, a deep learning model hierarchical offloading model TIME=F(CT′, T, S)+t is constructed by taking the theoretical hierarchical computing delay CT′ of the each edge computing node obtained in step S3 and the data transmission delay T and a propagation delay S obtained in step S4 as inputs, and taking corresponding response delay TIME as an output. A deep learning model hierarchical offloading model with the minimum response delay TIME is obtained by taking a minimum response delay TIME as an optimization target, where t denotes a time duration from a time instant when the edge computing node receives the computing task sent by the physical terminal to a time instant when the deep learning model hierarchical offloading model is generated.

In step S6, the hierarchical computing delay predication model CT_{c}; is applied according to the cloud server computing delay prediction model CT_{c} obtained in step S2 and the actual load condition of the computing resource of the cloud server. A theoretical hierarchical computing delay CT_{z}′ is obtained by taking the process of processing the image feature data D_{z} through the each DNN_{z} layer of the deep learning model to be offloaded as an input, and taking the computing delay corresponding to the image feature data D_{z} passing through each DNN_{z} layer of the deep learning model to be offloaded on the cloud server as an output.

A theoretical computing delay CT_{c}′ generated by using the cloud server to separately process the computing task is calculated according to a following formula

$${CT}_{c}^{′} = {CT}_{1}^{′} + {\sum }_{z = 2}^{n - 1} {CT}_{z}^{′} ,$$

where CT₁′ denotes a computing delay generated by passing the D1 through a DNN₁, and then a response delay TIMEc for separately processing the image feature data D_{z} by the cloud server is calculated according to a following formula TIME_{c}=F(CT_{c}′, T_{c}, S_{c}).

In step S7, a size of a response delay TIMEc when the cloud server is separately used is dynamically compared with a size of a minimum response delay TIME of the deep learning model hierarchical offloading model, in a case TIME is less than the TIMEc, the deep learning model hierarchical offloading model corresponding to the minimum response delay time TIME is taken as a hierarchical offloading strategy to complete an offloading computation of to-be-calculated data by minimizing the response delay as a target; otherwise, the separately used cloud server corresponding to the response delay TIMEc is taken as an eventual hierarchical offloading strategy to process the to-be-calculated data to compete the offloading computation of the to-be-calculated data by minimizing the response delay.

In step S8, a computing load condition and an actual calculating delay during a computing task by the each edge computing node executing the hierarchical offloading strategy are collected based on the hierarchical offloading strategy obtained in step S7, and then step S2 is returned to.

Further, the each DNN layer of the deep learning model to be offloaded is obtained by a following method. Neurons contained in a hidden layer, an input layer, and an output layer of the deep learning model to be offloaded are divided into n columns based on an individual columns of neurons, and an individually listed neuron column is obtained; and then DNN_{z} is obtained.

$${DNN}_{Z} = \{ \begin{matrix}a first neurons column , a second neurons column , and a network structure \\ between the first neurons and the second neurons column , z = 1 ; \\ a z + 1 - th neurons column , and a network structure between \\ a z - th neurons column and the z + 1 - th neurons column , 1 < z < n ;\end{matrix} ,$$

where n denotes an positive integer.

Further, the step S1 is specifically as follows.

A hierarchical computing delay model of the each edge computing node based on each DNN_{z} layer of a segmented deep learning model to be offloaded is respectively constructed by taking a process of processing the image feature data D_{z} through the each divided DNN_{z} layer of the deep learning model to be offloaded on the each edge computing node as an input, taking a computing delay corresponding to the image feature data D_{z} passing through each DNN_{z} layer of the deep learning model to be offloaded on the each edge computing node as an output, and the formula is expressed as CT=f(α, β, γ), where α denotes a preset central processing unit (CPU) load for a load condition of the computing resource, β denotes a preset graphics processing unit (GPU) load for the load condition of the computing resource, and γ denotes a preset cache load for the load condition of the computing resource.

In step S4, based on the local area network bandwidth condition r of the known edge computing nodes and the physical distances l between the each edge computing node, the data transmission delay T and the propagation delay S required by transmitting the image feature data D_{z} passing through the each edge computing node to the other edge computing nodes are respectively calculated according to following formulas:

T=D_{z}/r,

S=I/C;
where a speed of light C denotes a propagation rate of electromagnetic waves on a channel.

Further, the edge computing node includes a deep reinforcement network, a situation sensing center, and a decision receiving/transmitting center.

The deep reinforcement network includes a hierarchical computing delay prediction module, a transmission delay computing module, an online decision delay statistics module, an online learning module, an offline sample data storage module and a decision information generation module.

The hierarchical computing delay prediction module is configured to calculate the theoretical hierarchical computing delay CT′ and CT_{c}′, as well as store the hierarchical computing delay prediction model CT and the cloud server computing delay prediction model CT_{c}.

The transmission delay computing module is configured to calculate the data transmission delay T and the propagation delay S.

The online decision delay statistics module is configured to calculate a time duration t from a time instant when the edge computing node receives the computing task sent by the physical terminal to a time instant when the deep learning model hierarchical offloading model is generated.

The online learning module is configured to collect and transfer the actual load condition of the computing resource and the actual computing delay data during the computing task to the hierarchical computing delay prediction module at the edge computing node.

The offline sample data storage module is configured to store a corresponding computing delay of the image feature data D_{z} passing through the each DNN_{z} layer of the deep learning model to be offloaded on the each edge computing node, as well as a corresponding computing delay of the image feature data D_{z} passing through the each DNN_{z} layer of the deep learning model to be offloaded on the cloud server under the preset load condition.

The decision information generation module is configured to transmit an eventually generated hierarchical offloading strategy to the decision receiving/transmitting center.

The situation sensing center includes an edge computing node computing capability sensing module, a cloud server computing capability perception module, a network telemetry module and the decision receiving/transmitting center.

The edge computing node computing capability sensing module is configured to calculate the load condition of the computing resource of the each edge computing node.

The cloud server computing capability perception module is configured to calculate the load condition of the computing resource of the cloud server.

The network telemetry module is configured to calculate the local area network bandwidth condition r of the each edge computing node, and the physical distances l between the each edge computing node.

The decision receiving/transmitting center is configured to transmit and receive the eventually hierarchical offloading strategy.

Further, the cloud server includes the deep learning model and the decision receiving/transmitting center; the deep learning model is a pre-trained deep learning model; and the decision receiving/transmitting center is configured to receive the eventually hierarchical offloading strategy.

The above technical solutions are adopted by the present disclosure, and has the following beneficial effects compared to the prior art.
(1) Different from the deep learning model execution framework dominated by the physical end and the cloud computing center, by combining the edge computing paradigm and the cloud computing, and offloading the deep learning model to different edge computing nodes in layers, the computing potentiality of the edge side is fully exploited by the method, and the response delay of computing tasks is minimized on the premise of satisfying the computing accuracy.
(2) Through theoretically modeling the computing delay, data transmission delay, data propagation delay, and the delay of generating the model hierarchical offloading strategy during the entire deep learning model inference process, by taking minimizing the computing task response delay as the optimization target, the optimal hierarchical offloading strategy for the deep learning model is determined, and eventually the inference acceleration of the deep learning model is implemented.
(3) The method is developed under the premise of offline learning. Further, according to the actual measured loading condition of the computing resource and the computing delay during each task, the hierarchical computing delay prediction model is updated by the method in real time, to optimize the decision-making process of offloading the deep learning model in layers.
(4) The deep learning model is offloaded in layers to the edge computing nodes and the edge computing nodes such as the cloud server, and the collaborative reasoning means can effectively ensure the security of computing data and reduce the occupancy of network bandwidth.

### BRIEF DESCRIPTION OF DRAWINGS

FIG. 1 illustrates a schematic diagram of the present disclosure.

FIG. 2 illustrates a simulation diagram of module composition of a deep reinforcement network in the present disclosure.

FIG. 3 illustrates a simulation diagram of a hierarchical offloading principle of the deep learning model in the present disclosure.

FIG. 4 illustrates a flowchart of a method in the present disclosure.

### DESCRIPTION OF EMBODIMENTS

In order to better understand the technical contents of the present disclosure, specific embodiments are specifically given and are described below with reference to the accompanying drawings.

The aspects of the present disclosure are described with reference to the accompanying drawings, in which a plurality of illustrative embodiments are illustrated. The embodiments of the present disclosure are not limited to the drawings described. It should be understood that the present disclosure is implemented by an arbitrary one of the various concepts and embodiments described above and the concepts and embodiments described in detail below, as the conception and embodiment disclosed herein are not limited to an arbitrary embodiment. Additionally, a plurality of aspects in the disclosure may be used alone or in an suitable combination of other aspects disclosed herein.

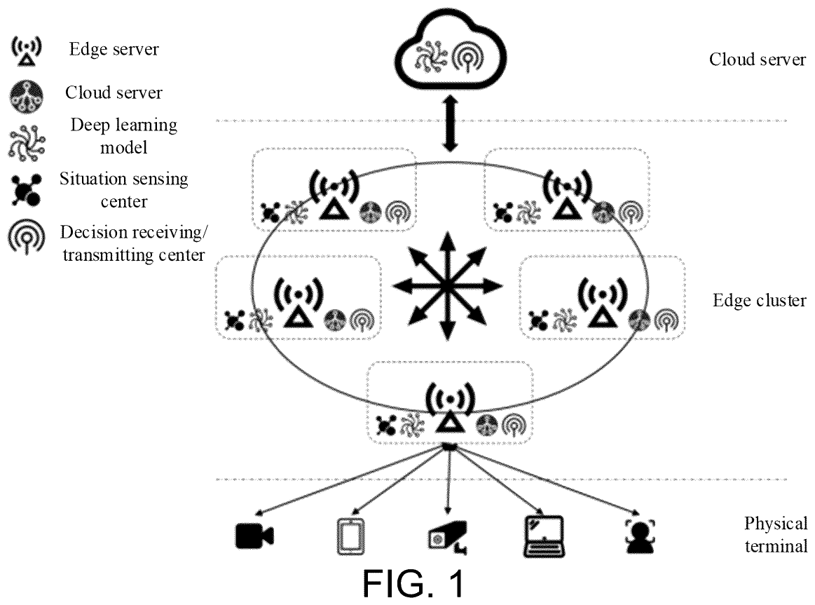

As illustrated in FIG. 1, based on a cloud server, at least two edge computing nodes are provided within a communication range of the cloud server C, the edge computing nodes are deployed on a WiFi access point or a base station, and at least one physical terminal is arranged in a local area network where the edge computing nodes are located. The distance between each edge computing node and each physical terminal in the communication range thereof is less than the distance between the edge computing node and the cloud server. An arbitrary edge computing node i within the communication range of the cloud server c, the total number of other edge computing nodes whose physical distance is less than the preset distance within the communication range of the edge computing node i is expressed as N, and 1≤j<N, where j is the number of each edge computing node within the communication range of the edge computing node I that is less than the preset distance, and an edge cluster is formed by the N edge computing nodes together with the edge computing node i. A deep learning model and a decision receiving/transmitting center are deployed on the cloud server c; and a deep reinforcement network, a deep learning model, a situation sensing center, and a decision receiving/transmitting center are deployed on the edge computing node.

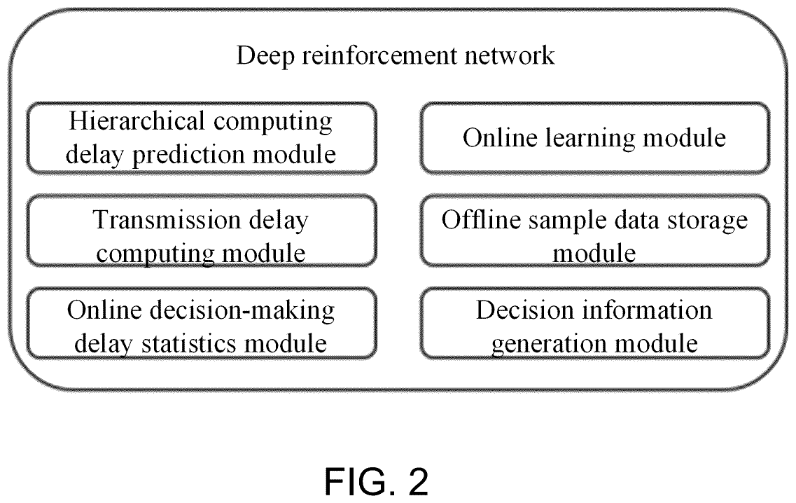

As illustrated in FIG. 2, the deep reinforcement network is deployed on the edge computing node, and the deep reinforcement network includes a hierarchical computing delay prediction module, a transmission delay computing module, an online decision delay statistics module, an online learning module, an offline sample data storage module, and a decision information generation module. By minimizing the computation task response delay TIME as a target, in a comprehensive consideration of the data transmission delay T, the data propagation delay S, the deep learning model hierarchical computing delay CT and the decision delay T, the optimal offloading strategy for the hierarchically offloading the deep learning model to each computing node is found to implement rapid inference of the deep learning model. The hierarchical computing delay prediction module is configured to calculate the theoretical hierarchical computing delay, the transmission delay computing module is configured to calculate the data transmission delay T and the propagation delay S; the online decision delay statistics module is configured to calculate a time duration t from a time instant when the edge computing node receives the computing task sent by the physical terminal to a time instant when the deep learning model hierarchical offloading model is generated; the online learning module is configured to collect and transfer the actual load condition of the computing resource and the actual computing delay data during the computing task to the hierarchical computing delay prediction module at the edge computing node. The actual computing delay refers to the computing delay corresponding to the image feature data D_{z} passing through each DNN_{z} of the deep learning model to-be-offloaded on each edge computing node during each edge computing node perform the computing task.

The offline sample data storage module is configured to store the hierarchical computing delay prediction model CT, decision information generation module is configured to transmit the eventually generated hierarchical offloading strategy to the decision receiving/transmitting center; the deep learning model is a well-trained deep learning model; the situation sensing center includes a computing capability sensing module and a network telemetry module; the computing capability sensing module is configured to calculate a load condition of the computing resource on each edge computing node; the network telemetry module is configured to calculate the network bandwidth condition r of the local area network where the each edge computing node is located, and is configured to calculate a physical distance l between the each edge computing node; and the decision receiving/transmitting center is configured to receive the eventually hierarchical offloading strategy.

The cloud server c includes the deep learning model and the decision receiving/transmitting center; the deep learning model is a pre-trained deep learning model; and the decision receiving/transmitting center is configured to receive the eventually hierarchical offloading strategy. The situation sensing center includes a computing capability sensing module and a network telemetry module.

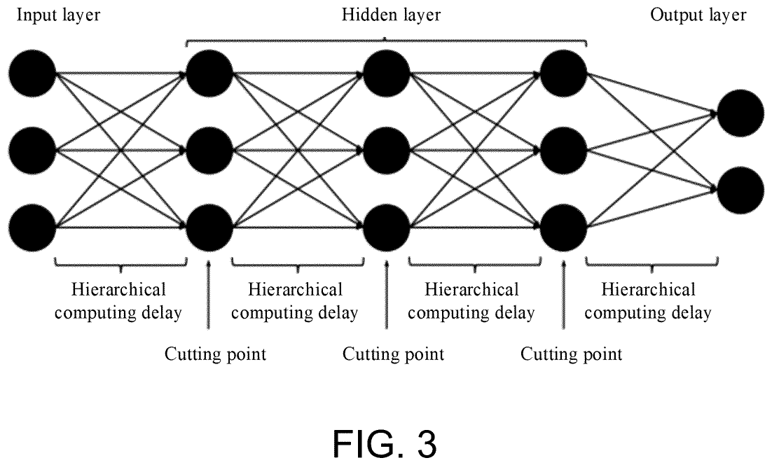

As illustrated in FIG. 3, the deep learning model is a multi-layer structure, neurons included in the hidden layer, the input layer, and the output layer of the deep learning model to be offloaded are divided into n columns by using the individual column of neurons, and individually listed neuron column is obtained and then the DNN_{z} is obtained,

$${DNN}_{Z} = \{ \begin{matrix}a first neurons column , a second neurons column , and a network structure \\ between the first neurons and the second neurons column , z = 1 ; \\ a z + 1 - th neurons column , and a network structure between \\ a z - th neurons column and the z + 1 - th neurons column , 1 < z < n ;\end{matrix} ,$$

where n denotes an positive integer.

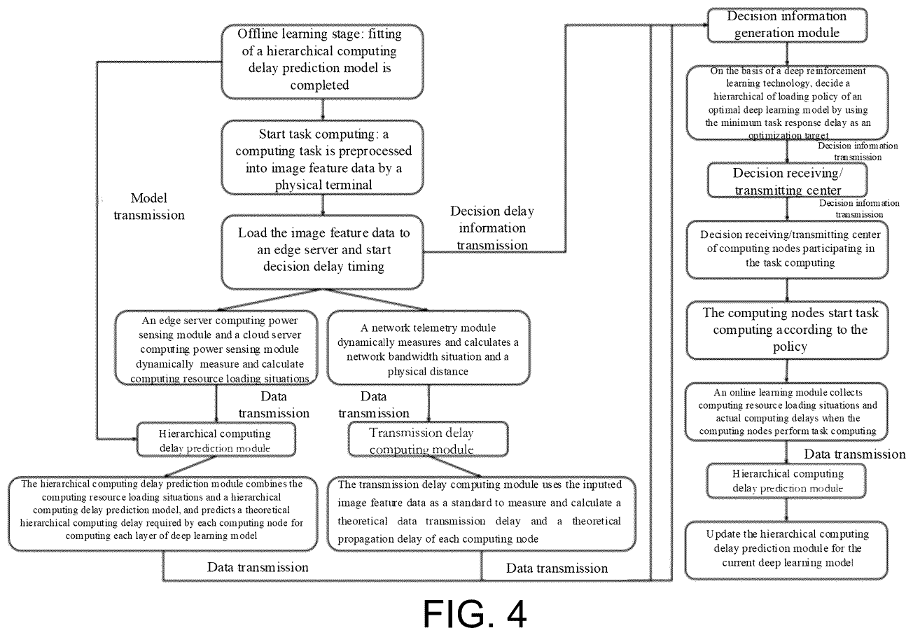

As illustrated in FIG. 4, in view of an arbitrary one of edge computing node i in the communication range of the cloud server c, it is assumed that the total number of other edge computing nodes whose physical distance is less than the preset distance within the communication range of the edge computing node i is expressed as 2, and I and II respectively denote the number of the two edge computing nodes, and the two edge computing nodes form an edge cluster together with the edge computing node i, that is, there are three edge computing nodes in this edge cluster.

It is assumed that the deep learning model to be offloaded has three columns of neurons, it can be divided into two layers of deep learning models to be offloaded (DNN₁, DNN₂), where 1≤z<2.

In the offline learning stage, in the case of different loading conditions of the computing resources of the edge computing nodes i, I, II and the cloud server c, by taking the general single image feature data D₁ as an input, the hierarchical computing delay CT_{iz}, CT_{Iz} and CT_{IIz} required by each edge computing node to perform each layer of deep learning mode, as well as the hierarchical computing delay CT_{cz} required by the cloud server c to perform each layer of deep learning mode are respectively measured. The hierarchical computing delays corresponding to above each edge computing node under different loading condition of the computing resources are recorded in the offline sample data storage module under the deep reinforcement network.

The load of the computing resource includes a CPU load α, a GPU load β, and a cache load γ.

Secondly, based on the deep reinforcement learning technology, the hierarchical computing delay prediction module performs a multivariate nonlinear function fitting by using the sample data in the offline sample data storage module to obtain the hierarchical computing delay prediction model:

CT_{iz}=f(αᵢ,βᵢ,γᵢ)

The above formula indicates that on an arbitrary one of the three edge computing nodes i under the edge cluster, in a case where the CPU load, the GPU load and the cache load are respectively expressed as αᵢ, βᵢ and γᵢ, the computing delay CT_{iz} generated by the z-layer (DNN_{z}) of the deep computing learning model is calculated. The well-trained hierarchical computing delay prediction model is stored in the hierarchical computing delay prediction module.

CT_{Iz}=f(α_{I},β_{I},γ_{I}), CT_{IIz}=f(α_{II},β_{II},γ_{II}) the same as above.

CT_{cz}=f(α_{c},β_{c},γ_{c}).

The above formula indicates that on the cloud server c above the edge cluster, in a case where the CPU load, the GPU load and the cache load are respectively expressed as α_{c}, β_{c} and γ_{c}, the computing delay CT_{cz} generated by the z-layer (DNN_{z}) of the deep computing learning model is calculated. The well-trained hierarchical computing delay prediction model is stored in the hierarchical computing delay prediction module on the each edge computing node.

After the offline learning stage, the task computing is executed.

The computing task (image data) is pre-processed by the physical terminal into image data into image feature data D₁ with the same resolution and equal data volumes based on the image compression and image segmentation technology, and loaded to the edge computing node i located in the same local area network as the current physical terminal. The online decision delay statistics module of the edge computing node i starts timing and dynamically transmits the decision delay t to the decision information generation module (the decision delay t refers to the time period from the time instant when the edge computing node i receives the computing task to the time instant when the hierarchical offloading strategy of the deep learning model is generated.

The dynamically sensed edge computing load condition (bᵢ, b_{I}, b_{II}) of the computing resource of the edge computing node and the loading condition (b_{c}) of the computing resource of the cloud server c are transmitted to the hierarchical computing delay prediction module by the computing capability sensing module under the situation sensing center of the edge computing node i and the computing capability sensing module of the cloud server c. The dynamically measured edge computing nodes as well as the network bandwidth conditions (rᵢ, r_{I}, r_{II}, r_{c}) and the physical distances (l_{iI}, l_{iII}, l_{ic}, l_{III}, l_{Ic}, l_{IIc}) of the region where the cloud server is located are transmitted to the transmission delay computing module by the network telemetry module.

The hierarchical computing delay prediction module combines the loading conditions of the computing resources of the each edge computing node and the cloud server c, as well as the pre-stored hierarchical computing delay prediction module, to predict the theoretical hierarchical computing delay (CT_{iz}′, CT_{Iz}′, CT_{IIz}′) required by each edge computing node to perform each layer DNN_{z} of deep learning mode, as well as the hierarchical computing delay

$$( {CT}_{c}^{′} = {\sum }_{z = 1}^{2} {CT}_{cz}^{′} )$$

required by the cloud server c to separately perform all deep learning model. The above theoretical computing delay results are synchronously transmitted to the decision information generation module; the input image feature data D₁ are used as the standard of the transmission delay computing module to calculate the theoretical data transmission delay (Tᵢ, T_{I}, T_{II}) and theoretical propagation delay (S_{iI}, S_{iII}, S_{ic}, S_{III}, S_{Ic}, S_{IIc}) of the each edge computing node. The above theoretical delay computation results are synchronously transmitted to the decision information generation module:

Tᵢ=D_{z}/rᵢ, S_{iI}=l_{iI}/C.

The above denotes the data transmission delay Tᵢ and propagation delay S_{iI} required by transmitting image feature data D_{z} passing through edge computing node i to the edge computing node I. The data transmission delay Tᵢ is related to the image feature data to be transmitted D_{z}, the network bandwidth rᵢ of the edge computing node i, and the propagation delay S_{iI} is related to the channel length (estimated by physical distance l_{iI}) from edge computing node i to the edge computing node I, and the propagation rate of electromagnetic waves on the channel (estimated by light speed C):

Tᵢ=D_{z}/rᵢ′ S_{iII}=l_{iII}/C′ Tᵢ=D_{z}/rᵢ′

S_{ic}=l_{ic}/C′ T_{I}=D_{z}/r_{I}′ S_{III}=l_{III}/C′

T_{I}=D_{z}/rᵢ′ S_{Ic}=l_{Ic}/C′ T_{II}=D_{z}/r_{II}′ S_{IIc}=l_{IIc}/C

The same as above, the decision information generation module, based on the deep reinforcement learning technology, according to the theoretical hierarchical computing delay (CT_{iz}′, CT_{Iz}′, CT_{IIz}′) required by the each edge computing node to process each layer of deep learning model DNN₂, the theoretical computing delay

$$( {CT}_{c}^{′} = {\sum }_{z = 1}^{2} {CT}_{cz}^{′} )$$

and theoretical data transmission delay (Tᵢ, T_{I}, T_{II}), as well as the theoretical propagation delay (S_{iI}, S_{iII}, S_{ic}, S_{III}, S_{Ic}, S_{IIc}) required by the cloud server c to separately perform the computations of all deep learning model, by taking minimizing task response delay TIME as the optimization target, determines the optimal hierarchical offloading strategy for the deep learning model (different hierarchical offloading strategy corresponds to different task response delay TIME, and the goal is to find the optimal hierarchical offloading strategy): TIME=F(CT_{iz}′, CT_{Iz}′, CT_{IIz}′, Tᵢ, T_{I}, T_{II}, S_{iI}, S_{iII}, S_{ic}, S_{III}, S_{Ic}, S_{II})+t.

Furthermore, during the generation process of the hierarchical offloading strategy of the deep learning model, in order to avoid the task response delay TIME from getting stuck in an over optimization process, the response delay TIMEc when the cloud server c is separately used, that is (CT_{c}′+Tᵢ+S_{ic}), is dynamically compared with a size of a minimum response delay TIME of the deep learning model hierarchical offloading model, in a case where TIME is less than TIMEc, the deep learning model hierarchical offloading model corresponding to the minimum response delay time TIME is taken as a hierarchical offloading strategy to complete an offloading computation of to-be-calculated data by minimizing the response delay as a target; otherwise, the separately used cloud server corresponding to the response delay TIMEc is taken as an eventual hierarchical offloading strategy to process the to-be-calculated data to compete the offloading computation of the to-be-calculated data by minimizing the response delay.

The generated optimal hierarchical offloading strategy of the deep learning model is transmitted to the decision receiving/transmitting center by the decision information generation module (the hierarchical offloading strategy information includes the edge computing nodes participating in this computation and the number of layers of the deep learning model to be calculated by the edge computing nodes), and the strategy information is transmitted to the decision receiving/transmitting center of each edge computing node participating in this task computation through the decision receiving/transmitting center. Then the task computation is started by the edge computing node according to the strategy, and the task computation results are directly sent to the physical terminal.

The online learning module of each edge computing node participating in task computing collects the loading condition of the computing resource (CPU load, GPU load and cache load) and the actual computing delay during the computing task, and transmits all the above sample data to the hierarchical computing delay prediction module of edge computing node i to update the hierarchical computing delay prediction model for the current deep learning model. Further, all edge computing nodes share the updated hierarchical computing delay prediction model.

Although the present disclosure is described above with preferred embodiments, it is not intended to define the present disclosure. Those person skill in the art to which the present disclosure belongs may make various changes and embellishments without departing from the spirit and scope of the present disclosure. Therefore, the protection scope of the present disclosure shall be subject to those defined in the claims.

1. A deep learning model reasoning acceleration method based on cloud-edge-end collaboration, wherein the cloud-edge-end collaboration refers to a cloud server, at least two edge computing nodes in communication with the cloud server, and at least one physical terminal, and a communication distance between the physical terminal and the edge computing nodes is less than a distance between the edge computing nodes and the cloud server, characterized in that the method comprises following steps:
step S1, pre-processing, by the physical terminal, image data into image feature data D₁ with a same resolution and an equal data volume, inputting each divided DNN layer of a deep learning model to be offloaded, that is, DNN_{z}, and taking an output of a previous layer as an input of a next layer, and eventually obtaining image feature data D_{z};
step S2, executing an offline learning stage: calculating, according to each edge computing node, a resource preset load condition, constructing and training, by taking a process of processing the image feature data D_{z} through the each divided DNN_{z} layer of the deep learning model to be offloaded on the each edge computing node as an input, taking a computing delay corresponding to the known image feature data D_{z} passing through each DNN_{z} layer of the deep learning model to be offloaded on the each edge computing node as an output, a hierarchical computing delay prediction model CT;
at a same time, constructing and training, by taking a process of processing the image feature data D_{z} through the each divided DNN_{z} layer of the learning model to be offloaded on the cloud server as an input, taking a computing delay corresponding to the image feature data D_{z} passing through each DNN_{z} layer of the deep learning model to be offloaded on a known cloud server as an output, a cloud server computing delay prediction model CT_{c} based on a preset load condition of a computing resource of the cloud server,
step S3, applying, according to an actual load condition of the computing resource of the each edge computing node, the hierarchical computing delay prediction model CT by an edge computing node corresponding to a computing task of the physical terminal, and obtaining, by taking the process of processing the image feature data D_{z} through the each DNN_{z} layer of the deep learning model to be offloaded as an input, taking a computing delay corresponding to the image feature data D_{z} passing through each DNN_{z} layer of the deep learning model to be offloaded on the each edge computing node as an output, a theoretical hierarchical computing delay CT′;
step S4, calculating, based on a local area network bandwidth condition r of known edge computing nodes and physical distances l between the each edge computing node, a data transmission delay T and a propagation delay S required by transmitting the image feature data D_{z} passing through a current edge computing node to other edge computing nodes; at a same time, calculating, based on a network bandwidth condition r_{c} of the known cloud server as well as physical distances l_{c} between edge computing nodes of the computing task and the cloud server, a data transmission delay T_{c} and a propagation delay Sc required by transmitting the image feature data D₁ passing through the edge computing node of the computing task to the cloud server;
step S5, constructing, by taking the theoretical hierarchical computing delay CT′ of the each edge computing node obtained in step S3 and the data transmission delay T and the propagation delay S obtained in step S4 as inputs, taking corresponding response delay TIME as an output, a deep learning model hierarchical offloading model TIME=F(CT′, T, S)+t, and
obtaining, by taking a minimum response delay TIME as an optimization target, a deep learning model hierarchical offloading model with the minimum response delay TIME, where t denotes a time duration from a time instant when the edge computing node receives the computing task sent by the physical terminal to a time instant when the deep learning model hierarchical offloading model is generated;
step S6, applying, according to the cloud server computing delay prediction model CT_{c} obtained in step S2 and the actual load condition of the computing resource of the cloud server, a hierarchical computing delay predication model CT_{c}; obtaining, by taking the process of processing the image feature data D_{z} through the each DNN_{z} layer of the deep learning model to be offloaded as an input, taking the computing delay corresponding to the image feature data D_{z} passing through each DNN_{z} layer of the deep learning model to be offloaded on the cloud server as an output, a theoretical hierarchical computing delay CT_{z}′;
calculating, according to a following formula
$${CT}_{c}^{′} = {CT}_{1}^{′} + {\sum }_{z = 2}^{n - 1} {CT}_{z}^{′} ,$$
a theoretical computing delay CT_{c}′ generated by using the cloud server to separately process the computing task, where CT₁′ denotes a computing delay generated by passing the D₁ through a DNN₁, and then calculating, according to a following formula TIMEc=F(CT_{c}′, T_{c}, S_{c}), a response delay TIMEc for separately processing the image feature data D_{z} by the cloud server;
step S7, dynamically comparing a size of a response delay TIMEc when the cloud server is separately used with a size of a minimum response delay TIME of the deep learning model hierarchical offloading model; in a case TIME is less than TIMEc, the deep learning model hierarchical offloading model corresponding to the minimum response delay time TIME is taken as a hierarchical offloading strategy to complete an offloading computation of to-be-calculated data by minimizing the response delay as a target; otherwise, the separately used cloud server corresponding to the response delay TIMEc is taken as an eventual hierarchical offloading strategy to process the to-be-calculated data to compete the offloading computation of the to-be-calculated data by minimizing the response delay; and
step S8, collecting, based on the hierarchical offloading strategy obtained in step S7, a computing load condition and an actual calculating delay during a computing task by the each edge computing node executing the hierarchical offloading strategy, and then returning to step S2.

2. The deep learning model reasoning acceleration method based on the cloud-edge-end collaboration according to claim 1, wherein the each divided DNN layer of the deep learning model to be offloaded is obtained by a following method:
dividing, based on an individual column of neurons, neurons contained in a hidden layer, an input layer, and an output layer of the deep learning model to be offloaded into n columns, and obtaining an individually listed neuron column; and then obtaining DNN_{z},
$${DNN}_{Z} = \{ \begin{matrix}a first neurons column , a second neurons column , and a network structure \\ between the first neurons and the second neurons column , z = 1 ; \\ a z + 1 - th neurons column , and a network structure between \\ a z - th neurons column and the z + 1 - th neurons column , 1 < z < n ;\end{matrix}$$
where n denotes an positive integer.

3. The deep learning model reasoning acceleration method based on the cloud-edge-end collaboration according to claim 2, wherein step S1 is specifically:
respectively constructing, by taking a process of processing the image feature data D_{z} through the each divided DNN_{z} layer of the deep learning model to be offloaded on the each edge computing node as an input, taking a computing delay corresponding to the image feature data D_{z} passing through each DNN_{z} layer of the deep learning model to be offloaded on the each edge computing node as an output, a hierarchical computing delay model of the each edge computing node as CT=f(α, β, γ) based on each DNN_{z} layer of a segmented deep learning model to be offloaded, wherein α denotes a preset central processing unit load for a load condition of the computing resource, β denotes a preset graphics processing unit load for the load condition of the computing resource, and γ denotes a preset cache load for the load condition of the computing resource.

4. The deep learning model reasoning acceleration method based on the cloud-edge-end collaboration according to claim 3, wherein in step S4, based on the local area network bandwidth condition r of the known edge computing nodes and the physical distances l between the each edge computing node, the data transmission delay T and the propagation delay S required by transmitting the image feature data D_{z} passing through the each edge computing node to the other edge computing nodes are respectively calculated according to following formulas:
T=D_{z}/r,
S=I/C;
where a speed of light C denotes a propagation rate of electromagnetic waves on a channel.

5. The deep learning model reasoning acceleration method based on the cloud-edge-end collaboration according to claim 4, wherein the edge computing node includes a deep reinforcement network, a situation sensing center, and a decision receiving/transmitting center; wherein the deep reinforcement network includes:
a hierarchical computing delay prediction module, configured to calculate the theoretical hierarchical computing delay CT′ and CT_{c}′, as well as store the hierarchical computing delay prediction model CT and the cloud server computing delay prediction model CT_{c};
a transmission delay computing module, configured to calculate the data transmission delay T and the propagation delay S;
an online decision delay statistics module, configured to calculate a time duration t from a time instant when the edge computing node receives the computing task sent by the physical terminal to a time instant when the deep learning model hierarchical offloading model is generated;
an online learning module, configured to collect and transfer the actual load condition and actual computing delay data during the computing task to the hierarchical computing delay prediction module at the edge computing node;
an offline sample data storage module, configured to store a corresponding computing delay of the image feature data D_{z} passing through the each DNN_{z} layer of the deep learning model to be offloaded on the each edge computing node, as well as a corresponding computing delay of the image feature data D_{z} passing through the each DNN_{z} layer of the deep learning model to be offloaded on the cloud server under the preset load condition of each edge computing node and the cloud server;
a decision information generation module, configured to transmit an eventually generated hierarchical offloading strategy to the decision receiving/transmitting center;
the situation sensing center includes:
an edge computing node computing capability sensing module, configured to calculate the load condition of the computing resource of the each edge computing node;
a cloud server computing capability perception module, configured to calculate the load condition of the computing resource of the cloud server;
a network telemetry module, configured to calculate the network bandwidth condition r of local area network where the each edge computing node is located, and the physical distances l between the each edge computing node;
the decision receiving/transmitting center, configured to transmit and receive the eventually hierarchical offloading strategy.

6. The deep learning model reasoning acceleration method based on the cloud-edge-end collaboration according to claim 5, wherein
the cloud server includes the deep learning model and the decision receiving/transmitting center; the deep learning model is a pre-trained deep learning model; and the decision receiving/transmitting center is configured to receive the eventually hierarchical offloading strategy.
